(19) United States
(12) Patent Application Publication
(10) Pub. No.: US 2010/0247948 A1
(43) Pub. Date: Sep. 30, 2010

(54) METHOD OF FORMING STRUCTURAL SANDWICH PLATE MEMBERS

(76) Inventor: Stephen John Kennedy, Ottawa (CA)

Correspondence Address: NIXON & VANDERHYE, PC, 901 NORTH GLEBE ROAD, 11TH FLOOR, ARLINGTON, VA, 22203, US

(21) Appl. No.: 12/744,569

(22) PCT Filed: Nov. 24, 2008
(86) PCT No.: PCT/GB08/03920

§ 371 Date: May 25, 2010

(30) Foreign Application Priority Data
Nov. 27, 2007 (GB) 0723239.0

(51) Int. Cl. B32B 15/04; B32B 7/08

(52) U.S. Cl. 428/594; 156/92

(57) ABSTRACT

A method of forming structural sandwich plate members involves connecting perimeter bars using at least one stud welded to one of the outer plates. The stud(s) may be arc stud welded to the outer plate through an aperture in the perimeter bar.

The present invention relates to methods of forming structural sandwich plate members, which comprise two outer plates and a core of plastics or polymer material bonded to the outer plates with sufficient strength to substantially contribute to the structural strength of the member, by overlay techniques and to the members and structures formed thereby.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems may be used in many forms of construction to replace stiffened steel plates, formed steel plates, reinforced concrete or composite steel-concrete structures and greatly simplify the resultant structures, improving strength and structural performance (e.g. stiffness, damping characteristics) while saving weight. The core transfers shear forces between the outer plates. Further developments of these structural sandwich plate members are described in WO 01/32414, also incorporated hereby by reference. As described therein, foam forms may be incorporated in the core layer to reduce weight and transverse metal shear plates may be added to improve stiffness.

According to the teachings of WO 01/32414, the foam forms can be either hollow or solid. Hollow forms generate a greater weight reduction and are therefore advantageous. The forms described in that document are not confined to being made of light weight foam material and can also be make of other materials such as wood or steel boxes, plastic extruded shapes and hollow plastic spheres.

A method of forming such members by overlay is described in International Application WO 02/20341. In this method, an existing structure can be reinstated or reinforced by positioning a new faceplate in spaced relation to a worn or damaged panel and injecting plastics or polymer material in liquid form into the resulting cavity. The plastics or polymer material sets or hardens to form an intermediate layer that bonds to the existing panel and the new faceplate to transfer shear forces therebetween. A variant of this method, by which tubular structures are reinforced internally is described in International Application PCT/GB2003/004628. This variant is sometimes referred to as innerlay. Particular methods adapted to the repair and reinforcement of bridges are described in WO 02/20341. These are something referred to as underlay. The use of magnets is to hold down restraint beams is described in WO 2005/108072.

In known overlay techniques (including variants such as innerlay and underlay mentioned above) the cavity into which the core material is injected is formed by fillet welding perimeter bars along their lengths to the panel or other structure to be reinforced then butt welding the face plates to the perimeter bars. In rare cases, the new faceplate can be fillet welded directly to existing parts of the structure. However, in some cases welding to the existing structure is undesirable, e.g. because the heat generated will damage the existing structure or things attached to it, such as insulation. Hot work may also be restricted because of the pressure of flammable materials, such as fuel vapour.

An alternative method of forming the cavity for injection is therefore desirable.

It is an aim of the present invention to provide an alternative method of forming a cavity for injection of core material to form a structural sandwich plate member as an addition to an existing structure.

According to the present invention, there is provided a method of manufacturing a structural sandwich plate member, comprising the steps of:

providing a first metal plate,

providing at least one perimeter bar having at least one through-hole in contact with said first metal plate so that a stud or studs fixed to said first metal plate projects into said through-hole(s);

fixing said perimeter bar to said stud(s);

fixing a second metal plate to said perimeter bar so that the second metal plate is spaced from the first metal plate to form a cavity bounded by said first and second metal plates and said perimeter bar;

filling said cavity with uncured plastics or polymer material; and

allowing said plastics or polymer material to cure to bond said outer plates together with sufficient strength to transfer shear forces there between.

Further, the invention provides a structural sandwich plate member comprising first and second outer metal plates and a core of plastics or polymer material bonded to said metal plates with sufficient strength to transfer shear forces there between, the member further comprising a bar fixed to said first metal plate via a stud projecting from the first metal plate.

The studs can be attached by arc stud welding or variants on that technique. Use of a stud welding “gun” allows the studs to be attached extremely quickly and may also be automated. The studs may have an enlarged head to assist welding to the perimeter bars.

The materials, dimensions and general properties of the outer plates of the structural sandwich plate member of the invention may be chosen as desired for the particular use to which the structural sandwich plate member is to be put and in general may be as described in U.S. Pat. No. 5,778,813 and U.S. Pat. No. 6,050,208. Steel or stainless steel is commonly used in thicknesses of 0.5 to 20 mm and aluminium may be used where light weight is desirable. Similarly, the plastics or polymer core may be any suitable material, for example an elastomer such as polyurethane, as described in U.S. Pat. No. 5,778,813 and U.S. Pat. No. 6,050,208 and is preferably compact, i.e. not a foam. The material of the studs should be the same or weld compatible with the material of the perimeter bars and the dimensions of the studs will be selected according to the loads to be expected in injection of the core and/or in use of the finished structure. In the case that the existing panel and perimeter bar are made of dissimilar metals, a two part stud might be used.

The present invention will be described below with reference to exemplary embodiments and the accompanying schematic drawings, in which:

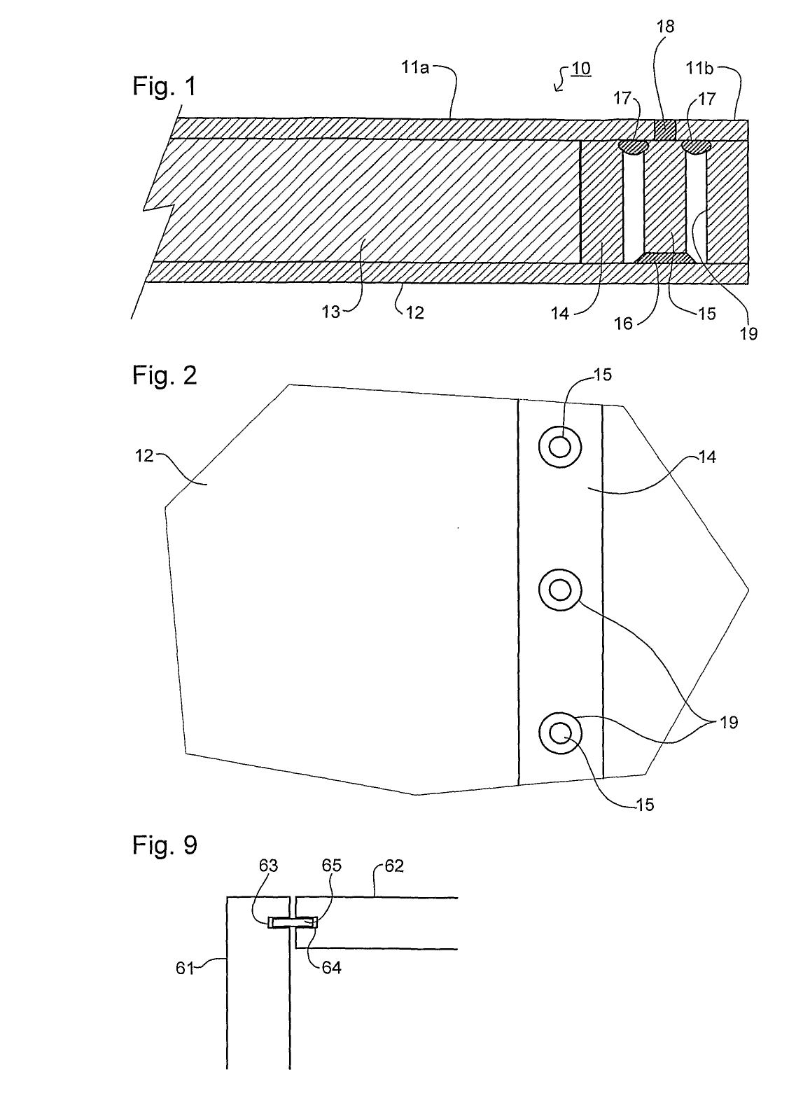

FIG. 1 is a partial cross-sectional view of a structural sandwich plate member according to an embodiment of the present invention;

FIG. 2 is a partial plan view of the structural sandwich plate member of FIG. 1 prior to positioning of the top plate;

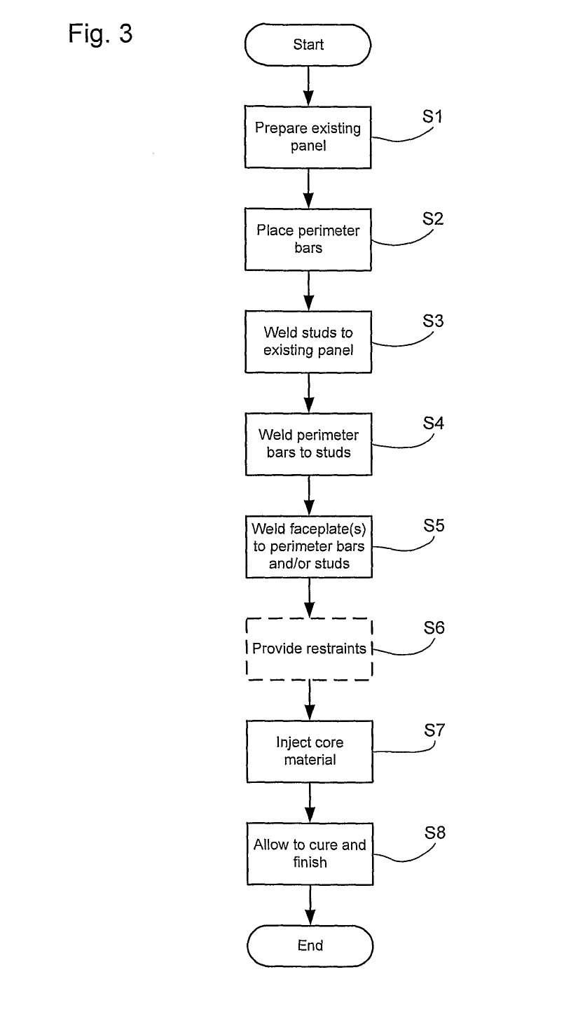

FIG. 3 is a flow diagram of a method according to an embodiment of the invention;

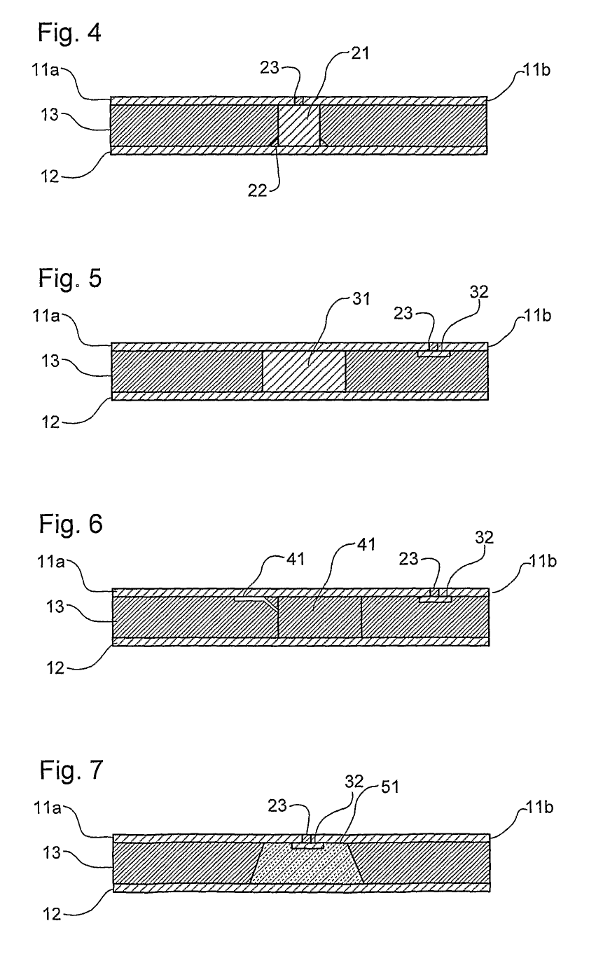

FIGS. 4 to 7 depict in cross-section alternative forms of perimeter bar useable with the invention;

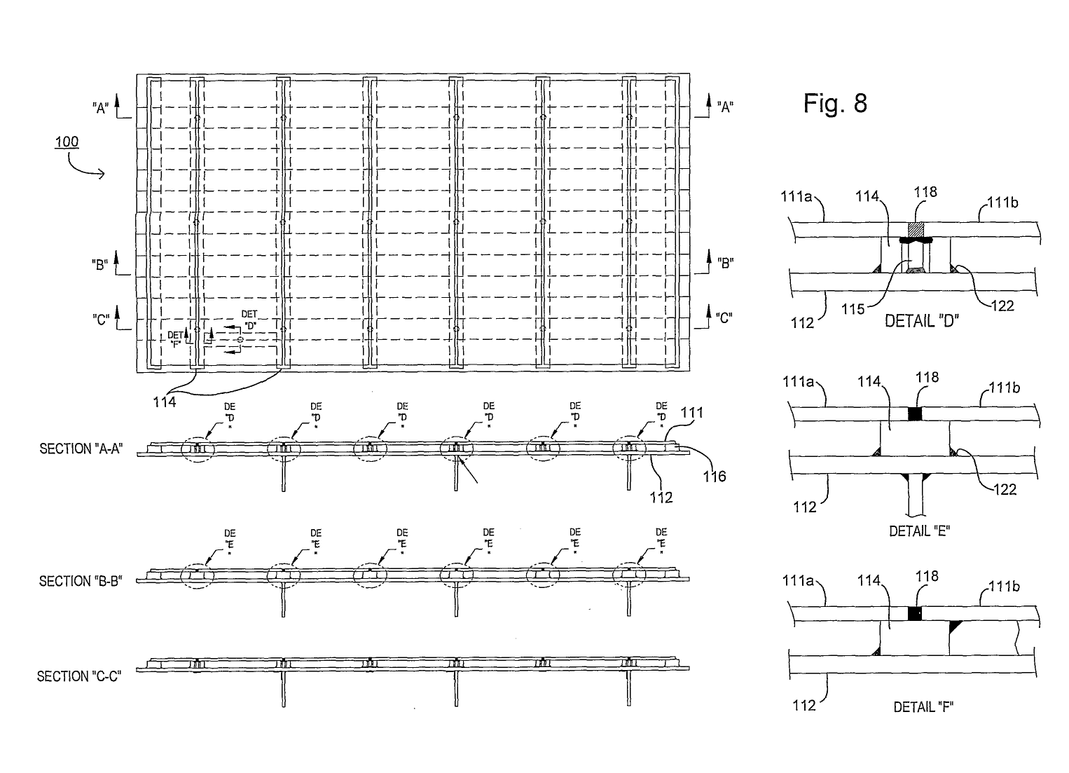

FIG. 8 depicts in plan, section and detail views an overlay to a ship deck using different methods for attaching perimeter bars; and

FIG. 9 depicts a method of joining two perimeter bars at their ends to form a frame.

In the various drawings, like parts are indicated by like reference numerals.

The structural sandwich plate member shown in FIGS. 1 and 2 comprises upper and lower outer plates (faceplates) 11, 12 which may be of steel or aluminium and have a thickness, for example, in the range of from 0.5 to 20 mm. Edge plates or perimeter bars are provided between the face plates 11, 12 around their outer peripheries to form a closed cavity. In the cavity between the face plates 11, 12 is a core 13 of plastics or polymer material, preferably a compact thermosetting material such as polyurethane elastomer. This core may have a thickness in the range of from 15 to 200 mm; in many applications 50 mm is suitable.

The core 13 is bonded to the face plates 11, 12 with sufficient strength and has sufficient mechanical properties to transfer shear forces expected in use between the two face plates. The bond strength between the core 13 and face plates 11, 12 should be greater than 3 MPa, preferably 6 MPa, and the modulus of elasticity of the core material should be greater than 200 MPa, preferably greater than 250 MPa, especially if expected to be exposed to high temperatures in use. For low load applications, such as floor panels, where the typical use and occupancy loads are of the order of 1.4 kPa to 7.2 kPa, the bond strength may be lower, e.g. approximately 0.5 MPa. By virtue of the core layer, the structural sandwich plate member has a strength and load bearing capacity of a stiffened steel plate having a substantially greater plate thickness and significant additional stiffening. The plate, of course, need not be flat but may take any form required for its intended use.

In many cases, the lower face plate 12 may be part of an existing structure—e.g. a ship or other maritime vessel—to which the structural sandwich plate member 10 is to be added as a repair or reinforcement. The lower faceplate may be corroded, worn or deformed rather than flat as shown. It should be noted that the terms “lower” and “upper” used herein refer to the position of the respective plate in the drawings and in an actual embodiment the structural sandwich plate member 10 may be at any angle or orientation.

FIGS. 1 and 2 show one perimeter bar 14 forming part of the sidewall of the structural sandwich plate member 10. As can be seen most clearly in FIG. 2, the perimeter bar 14 is provided with a series of apertures (through-holes) 19 and the lower face plate 12 is provided with a series of studs 15 which project into the apertures 19. The perimeter bar 14 is welded to the studs 15 by welds 17 and the upper face plates 11a, 11b are butt welded to each other and to the perimeter bar by butt weld 18. Although shown as cylinders the studs 15 may have enlarged heads to facilitate welding to the perimeter bar.

Thus, a method according to an embodiment of the invention for manufacturing the structural sandwich plate member 10 as an overlay is set out in FIG. 3.

The first step is to prepare S1 the lower face plate 12, which may form a panel of an existing structure. Exactly what preparation is required will depend on the condition of the plate 12 but may include: shot or sand blasting to remove rust and/or other forms of corrosion, wire brushing, grinding decreasing, chemical cleaning, repairing or filling cracks or crevices, and flattening of dents.

Next, in step S2 the perimeter bars 14 are placed on the lower plate 12 in the required positions around the space that is to be filled with core material. The perimeter bars have pre-formed apertures 19, which may be regularly spaced or irregularly spaced to provide additional strength in selected locations. The apertures 19 can be formed by drilling or punching, for example, and the spacing may be in the range of 0.5 to 10 m, preferably 1 to 5 m.

Once the perimeter bars are in place, the studs 15 are fixed, e.g. by welding, to the lower plate 12 through the aperture. This can be done conveniently by an arc stud welding procedure for which purpose the apertures 19 are over-sized relative to the studs 15 to accommodate the head of the stud-welding gun. It would also be possible to reverse steps S2 and S3, that is fix the studs to the lower plate first and place the perimeter bars afterwards, but the illustrated method avoids possible problems with mis-aligned studs and/or apertures. The height of the studs along the lower plate 12 after they are fixed in place is preferably equal to the thickness of the perimeter bar 14, or near enough thereto to enable easy welding to the perimeter bar. Over long studs could be cut down after welding but such an additional step is preferably avoided.

Step S4 is to fix the perimeter bars 14 to the studs 15, again by welding for example. Prior to doing this, it may be desirable to place a ring or collar (not shown) around the stud to at least partially fill the annular gap between the stud and the perimeter bar. This holds the perimeter bar in place more precisely and reduces heat conduction through the stud into the lower metal plate. If the perimeter bar 14 is welded to the studs, the weld 17 may need to be ground down flush with the surface of the perimeter bar. Then the second, upper face plates 11a and b are placed on the perimeter bar and butt welded together and to the perimeter bar, step S5. Butt welding the top face plates to each other and the perimeter bar can be done in a two stage process; fillet weld the first plate to the perimeter bar, then fillet weld the second and do a cap weld. Again, the resulting weld 18 may be ground flush with the surface of the face plates 11a and b.

Injection of the core 13 is the next required step, S7, but prior to that restraint beams, to prevent distortion of the face plates by the pressures experienced during injection and curing of the core material, may be put in place, step S6. The restraint beams may be temporarily welded in place or held in place by magnetic or mechanical clamps. After injection, the core material is allowed or caused to cure, step S8, and any finishing steps, such as removal of injection ports and filling of vent holes, may be carried out.

The advantage of the above method, as compared to fillet welding the perimeter bars to the lower face plate 12, is that the heat load imparted by the welding of the studs, particularly if an arc-stud welding technique is used, is very much lower. This means that the temperature of the lower face plate 12 does not rise so much and damage to heat sensitive components, such as insulation, on the underside thereof can be avoided. This has been confirmed by tests.

It should be noted that after the core has cured, the face plates and perimeter bars are bound together by the intermediate layer 13 so that in most cases the fixing of the perimeter bars to the face plates need only be sufficient to withstand loads encountered during the injection and curing steps, and not necessarily loads encountered during use of the structural sandwich plate member 10.

To improve sealing of the cavity, gaskets or sealing strips can be provided between the perimeter bar and face plates. A line of sealant may be provided to the join between existing panel at perimeter bar before the upper face plate is put in place. Such additional sealing measures are most desirable where the existing panel is significantly non-flat e.g. due to corrosion, wear or damage.

It will be appreciated that the side walls of the cavity into which the core material is to be injected can be defined by existing parts of the structure as well as perimeter bars and that not all perimeter bars need to be attached using the process described above. Various different means of attachment of the perimeter bars are shown in FIGS. 4 to 7.

FIG. 4 shows a known method of attachment in which the perimeter bar 21 is fillet welded 22 to the lower faceplate 12 along one or both sides and the upper face plates 11a, 11b are but to welded 23 together on top of the perimeter bar. This method can be used where the heat load can be accommodated and provides a secure fixing at low cost.

FIG. 5 shows a steel perimeter bar 31 which is bonded to the upper and lower face plates 11, 12 by structural adhesive (not shown). The two parts 11a, 11b of the upper faceplate are butt-welded 23 together along a line displaced from the perimeter bar 14 using a backing bar 32 fixed to the underside of one of the plates. This method is also useful where it is necessary to avoid applying a heat load to the lower face plate but the use of structural adhesive may not be convenient in all cases because of the difficulty of ensuring a reliable bond. In this method, the perimeter bar may be wider to provide greater area for the bond.

In FIG. 6, the perimeter bar 41 is a bar of set plastics or polymer material, the same as or compatible with the core material, adhered to the upper and lower face plates. A sealing lip 42 is provided to ensure a good seal for the cavity. As in the arrangement of FIG. 5, the two parts 11a, 11b of the upper faceplate are butt welded 23 together along a line displaced from the perimeter bar 14 using a backing bar 32 fixed to the underside of one of the plates. This method is likewise useful where it is desirable to avoid a heat load to the lower faceplate.

The perimeter bar shown in FIG. 7 comprises a bar of heat proof material, such as mineral wool, so that the upper face plates 11a, 11b can be welded together above it, rather than off to one side. A porous material such as mineral wool may be provided with an impervious coating along its sides to prevent ingress of the core material and/or improve the seal to the cavity. However, ingress of core material into such a perimeter bar may not be undesirable in which case the impervious layer may be omitted.

It is also possible to use magnets, either permanent or electromagnetic, to hold perimeter bars in place during injection and curing of the core since the perimeter bars will be held in place after curing of the adhesive. Also, where a large overlay is divided into sections (e.g. to enable reliable injection and reduce pressure during injection and curing), it may not be necessary that the perimeter bars contribute to the strength of the final structure so that their connection to the plates after curing of the core is not critical.

An example of an overlay job incorporating different techniques for fixing perimeter bars is shown in FIG. 8 which comprises a plan view of a ship deck and various cross-section and detail views A to F. The deck is of a fishing vessel which has an insulated hold under the deck so that there is insulating material on the underside of the deck. The insulation would be damaged by excess heat and also serves to hinder heat dissipation so that fillet welding a perimeter bar to the upper side of the deck risks damaging the insulation.

In this job, the deck 100 is divided into sections by laterally extending perimeter bars 114 which are fixed to the existing deck 112 by studs 115 as shown in detail “D”. The upper face plates 111a, 111b are butt welded at 118 to each other and the perimeter bar 114. Detail “E” at the side edges of the deck, the side bars 116 are held to the deck by fillet welds in the conventional manner. In the central portion of the deck there is insulation material on the underside and the use of stud connections avoids damage to it. At the side edges, there is no insulation so that filet welds can be used. Sealant 122 is applied along all joins between the perimeter bars 114 and existing deck 112.

Where perimeter bars meet, e.g. at the corners of a plate member or overlay section, a gap may exist that requires sealing. This can be done by filling the gap with a hardening sealant, a gasket or similar, or by welding the perimeter bars to form a frame. However, sealants and gaskets do not form a structural join between the perimeter bars so do not assist in resisting the injection pressure or contribute to the ultimate strength of the member, whilst welding may be undesirable in some applications, as discussed above. An alternative way of joining perimeter bars, not suffering form these disadvantages is shown in FIG. 9.

As shown in FIG. 9, two perimeter bars 61, 62 meet at a right-angled (for example) corner, but the method applies also to perimeter bars meeting at acute or obtuse angles or that are in-line. Notches 63, 64 of a predetermined size are cut at predetermined positions in opposing sides of the perimeter bars 61, 62 such that they are aligned when the perimeter bars are correctly positioned. A conventional notching machine appropriate to the thickness of the perimeter bar can be used. When the perimeter bars 61, 62 are in position, a metal slice or wedge 64 is driven into the two notches, e.g. by hammer, to connect the two perimeter bars. This step may be performed before or after the perimeter bars are fixed to the lower metal plate by any of the methods outlined above.

This method provides a join that has significant strength, sufficient at least to assist in resisting injection forces and to allow the resulting frame to be positioned as a unit. The join also provides a seal to prevent escape of the core material during injection. Notching and formation of the metal slices can be performed in factory conditions to ensure required accuracy whilst no special equipment is required on site. Hot work, e.g. welding, is avoided and savings may be made through the reduction of use of materials and labour.

Conventionally, and in the above description, overlay and related techniques for forming structural sandwich plate members have been used for the reinforcement, repair or reinstatement of existing, worn damaged or corroded structures. To construct new vessels or structures from structural sandwich plate members, either prefabricated members have been used or the structure is constructed, section by section, with spaced apart metal plates to form cavities that are filled with elastomer as each section is complete. However, an alternative method of construction is possible. In this alternative method, the structure, or a substantial part of it, is constructed from a single layer of metal. At this stage the structure is likely not sufficiently strong to bear the full operational loads expected but is strong enough to support itself against gravity and loads to be expected in construction. Then, in parts of the structure that require additional support to bear operational loads, an overlay is performed on the unused structure, i.e. before it enters into service. For example, a ship or boat might be constructed as a single-skin hull, with decks and internal bulkheads but no superstructure. The resulting shell would be structurally self-supporting but not able to bear the superstructure or cargo. To bring the vessel up to full specification, an overlay is applied to the in- or out-side of the hull, decks and/or bulk heads.

It will be appreciated that the above description is not intended to be limiting and that other modifications and variations fall within the scope of the present invention, which is defined by the appended claims.

1. A method of manufacturing a structural sandwich plate member, comprising the steps of:
providing a first metal plate,
providing at least one perimeter bar, having at least one through-hole, in contact with said first metal plate so that a stud or studs fixed to said first metal plate projects into said through-hole(s);
fixing said perimeter bar to said stud(s);
fixing a second metal plate to said perimeter bar so that the second metal plate is spaced from the first metal plate to form a cavity bounded by said first and second metal plates and said perimeter bar;
filling said cavity with uncured plastics or polymer material; and
allowing said plastics or polymer material to cure to bond said outer plates together with sufficient strength to transfer shear forces there between.

2. A method according to claim 1, wherein said step of providing at least one perimeter bar comprises the steps of placing the bar on the first metal plate and then fixing sad stud to said first metal plate.

3. A method according to claim 2, wherein said stud is fixed to said first metal plate by arc stud welding.

4. A method according to claim 1, wherein the step of fixing said perimeter bar to said stud comprises welding said perimeter bar to said stud.

5. A method according to claim 1, further comprising the step of placing a ring around said stud to at least partially fill an annular space between said stud and said perimeter bar prior to the step of fixing said perimeter bar to said stud.

6. A method according to claim 1, wherein the or each stud projects away from the first metal plate by a distance substantially equal to the thickness of the perimeter bar.

7. A method according to claim 1, further comprising the step of fixing another perimeter bar, defining another bound of the cavity, to the first metal plate by another method.

8. A structural sandwich plate member comprising first and second outer metal plates and a core of plastics or polymer material bonded to said metal plates with sufficient strength to transfer shear forces therebetween, the member further comprising a bar fixed to said first metal plate via a stud projecting from the first metal plate.

9. (canceled)

10. (canceled)
